(19) United States
(12) Patent Application Publication
(10) Pub. No.: US 2020/0402399 A1
(43) Pub. Date: Dec. 24, 2020

(54) METHOD FOR GUIDING TRAFFIC FLOW IN VEHICLE-DENSE REGIONS BASED ON THREE-DIMENSIONAL TRAFFIC SYSTEM

(71) Applicant: Beihang University, Beijing (CN)

(72) Inventors: Xuting DUAN, Beijing (CN); Daxin TIAN, Beijing (CN); Wensheng ZHAO, Beijing (CN); Jianshan ZHOU, Beijing (CN); Kunxian ZHENG, Beijing (CN); Chuang ZHANG, Beijing (CN); He LIU, Beijing (CN); Yinsheng GONG, Beijing (CN)

(73) Assignee: Beihang University, Beijing (CN)

(21) Appl. No.: 16/904,711

(22) Filed: Jun. 18, 2020

(30) Foreign Application Priority Data
Jun. 21, 2019 (CN) 201910544317.4

(51) Int. Cl. G08G 1/0968; G08G 1/01; G08G 1/048; G08G 1/0967; B64C 39/02

(52) U.S. Cl. CPC G08G 1/096833; G08G 1/012; G08G 1/048; B64C 2201/146; G08G 1/096791; B64C 39/024; B64C 2201/127; G08G 1/096708

(57) ABSTRACT

The present invention provides a method for guiding traffic flow in vehicle-dense regions based on a three-dimensional traffic system, relating to a method to alleviate traffic pressure. The method includes: positioning a drone above the downstream of a vehicle-dense region; aerially photographing traffic condition information, and acquiring image data information from a captured traffic condition information image; determining traffic guidance information for a vehicle upstream to the vehicle-dense region; transmitting by the drone the determined traffic guidance information to a vehicle-mounted terminal of an upstream vehicle, transmitting by a downstream vehicle its traffic guidance information to the vehicle-mounted terminal of the upstream vehicle; weighting by the vehicle-mounted terminal of the upstream vehicle the traffic guidance information from the drone and from the downstream vehicle, and transmitting the result to a vehicle display; driving by a driver according to information displayed on the vehicle display until the vehicle leaves the vehicle-dense region. The present invention can effectively reduce the driver's frequent “start-stop” maneuver, so that the vehicle can pass the dense region slowly and smoothly.

### TECHNICAL FIELD

The present disclosure relates to a method to alleviate traffic pressure, in particular to a method for guiding traffic flow in vehicle-dense regions based on a three-dimensional traffic system.

### BACKGROUND

With the continuous improvement of people's living standards, China's car ownership is increasing rapidly, and major cities are facing more and more serious traffic pressure while enjoying prosperity. In order to alleviate traffic congestion, some cities have adopted measures such as motor vehicle purchase restriction, road space rationing based on license plate number, etc. However, during rush hours traffic congestion problems cannot be effectively solved. Due to the high density of vehicles on crowded roads, and the need for drivers to frequently switch back and forth between the accelerator pedal and the brake pedal, traffic accidents can occur inadvertently. Traffic accidents cause property damage to people, and more seriously, threaten the personal safety of drivers and passengers.

In an intelligent transportation system, traffic guidance information is an important information to alleviate traffic congestion and improve traffic safety. As an important equipment for publishing traffic status and traffic guidance information, the variable message board plays an important role in alleviating traffic congestion. At present, mostly variable message boards are set up in vehicle-dense regions to transmit traffic guidance information to road users. However, there are drawbacks in the method by setting up variable message boards in vehicle-dense regions. Main drawbacks include: the accuracy of the variable information board is low, data update is slow, and the traffic guidance information on the variable information board can only induce vehicles that have not entered the dense region to choose another road, and for vehicles already in the dense region, the variable information board has little effect.

### SUMMARY OF PARTICULAR EMBODIMENTS

In view of the drawbacks in the prior art, the present disclosure provides a method for guiding traffic flow in vehicle-dense regions based on a three-dimensional traffic system, which mainly includes inducing a vehicle that is already in a dense region by transmitting real-time traffic guidance information to a vehicle-mounted terminal via a drone, so that the driver can perceive the data directly and drive away from the dense region more safely and smoothly.

In order to achieve the above object, the technical solution of the present disclosure includes a method for guiding traffic flow in vehicle-dense regions based on a three-dimensional traffic system, comprising the following steps:

S1: remotely controlling a drone to fly above the downstream of a vehicle-dense region, and adjusting a flight status of the drone and an angle of a camera on the drone so that the camera faces stably and directly towards the ground;

S2: aerially photographing traffic condition information of the vehicle-dense region through drone aerial photography technology, and acquiring by the drone image data information from a captured traffic condition information image, where the image data information comprises road surface status information of the vehicle-dense region, the height of the drone from the ground of the vehicle-dense region, and the distance between the drone and a vehicle at different times;

S3: determining, by the drone, traffic guidance information for a vehicle upstream to the vehicle-dense region according to the image data information acquired in step S2, where the traffic guidance information comprises a recommended vehicle speed in the traveling of the vehicle, a shortest distance that the driver needs to maintain from a preceding vehicle, and an expected amount of time for the vehicle to pass the dense region;

S4: transmitting, by the drone, the traffic guidance information determined in step S3 to a vehicle-mounted terminal of an upstream vehicle; and transmitting, by a vehicle downstream to the vehicle-dense region, its traffic guidance information to the vehicle-mounted terminal of the upstream vehicle through V2V communication technology;

S5: weighting, by the vehicle-mounted terminal of the upstream vehicle, the traffic guidance information from the drone and the traffic guidance information from the downstream vehicle, and transmitting a traffic guidance information result from the weighting to a vehicle display;

S6: maintaining, by a driver of the upstream vehicle, a safe distance from a preceding vehicle according to information displayed on its vehicle display, and driving smoothly according to the recommended vehicle speed until the vehicle leaves the vehicle-dense region.

In the technical solution above, the traffic guidance information in step S3 is determined by calculation; the recommended speed Weight_V̅₁ for an upstream vehicle in the traveling of the vehicle is calculated according to a calculation formula:

$$Weight\_ {\overline{V}}_{1} = \frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}} \text{;} \qquad ( 1 )$$

the shortest distance S₁ that the driver needs to maintain from a preceding vehicle in the traveling of the upstream vehicle is calculated according to a calculation formula:

$${S}_{1} = \frac{\frac{{\sum }_{i = 1}^{n} \frac{1}{\frac{1}{{m}_{1}} {\sum }_{i = 1}^{{m}_{1}} \frac{{t}_{2} - {t}_{1}}{\begin{matrix}{l}_{1} cos {sin}^{- 1} \frac{h}{{l}_{1}} + \\ {l}_{2} cos {sin}^{- 1} \frac{h}{{l}_{2}}\end{matrix}}} \cdot {x}_{i}^{2}}{{\sum }_{i = 1}^{n} {x}_{i}}}{2 g μ} \text{;} \qquad ( 2 )$$

the expected amount of time T₁ for the upstream vehicle to pass the dense region in its traveling is calculated according to a calculation formula:

$${T}_{1} = \frac{L}{\frac{{\sum }_{i = 1}^{n} \frac{1}{\frac{1}{{m}_{1}} {\sum }_{i = 1}^{{m}_{1}} \frac{{t}_{2} - {t}_{1}}{\begin{matrix}{l}_{1} cos {sin}^{- 1} \frac{h}{{l}_{1}} + \\ {l}_{2} cos {sin}^{- 1} \frac{h}{{l}_{2}}\end{matrix}}} \cdot {x}_{i}}{{\sum }_{i = 1}^{n} {x}_{i}}} , \qquad ( 3 )$$

in the equations (1) (2) and (3) above, L is the remaining length of the vehicle-dense region, m1 is the number of vehicles in the vehicle-dense region that are observed by the drone, vehicle identifier is Nᵥ, where Nᵥ=1, 2, . . . , m, n is the number of drones in the vehicle-dense region, drone identifier is Nₐ, where Nₐ=1, 2, . . . , n;

xᵢ is the distance that a vehicle travels at different time, i is a natural number, t₁ and t₂ are different times that the drone aerially photographs, h is the height of the drone from the ground, l₁ is the distance between a drone Nₐ and a vehicle Nᵥ at time t₁, l₂ is the distance between a drone Nₐ and a vehicle Nᵥ at time t₂;

g is the gravitational acceleration, μ is a coefficient of friction between a vehicle tire and a road surface.

In the technical solution above, when an asphalt road surface is dry, the coefficient of friction between a vehicle tire and a road surface μ=0.8; when an asphalt road surface has accumulated water, the coefficient of friction between a vehicle tire and a road surface μ=0.4; when an asphalt road surface has snow accumulation, the coefficient of friction between a vehicle tire and a road surface μ=0.28; when an asphalt road surface has ice, the coefficient of friction between a vehicle tire and a road surface μ=0.18.

In the technical solution above, the traffic guidance information of the downstream vehicle itself in step S4 is obtained by calculation; given a real-time downstream vehicle speed V₂, m₂ vehicles have an average speed V̅₂ from the time t₁ to the time t₂ that can be calculated according to a calculation formula:

$${\overline{V}}_{2} = \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \text{;} \qquad ( 4 )$$

in the traveling of the downstream vehicle, a shortest distance S₂ that the driver needs to maintain from a preceding vehicle is calculated according to a calculation formula:

$${S}_{2} = \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \text{;} \qquad ( 5 )$$

in the traveling of the downstream vehicles, an expected amount of time T₂ for the vehicle to pass the dense region is calculated according to a calculation formula:

$${T}_{2} = \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}} , \qquad ( 6 )$$

where m₂ is the number of vehicles that are in the range of V2V communication of the vehicle upstream to the vehicle-dense region.

In the technical solution above, the traffic guidance information from step S5 is obtained based on the traffic guidance information calculated in steps S3 and S4, and calculated through weighting; the traffic guidance information from step S5 is calculated according to a calculation formula:

$$\{ \begin{matrix}Weight\_V = α \cdot \frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}} + ( 1 - α ) \cdot \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \\ Weight\_S = α \cdot \frac{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}^{2}}{{\sum }_{i = 1}^{n} {x}_{i}}}{2 g μ} + ( 1 - α ) \cdot \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \\ Weight\_T = α \cdot \frac{L}{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}}} + ( 1 - α ) \cdot \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}}\end{matrix} , \qquad ( 7 )$$

in equation (7) above, Weight_V is the recommended speed for a vehicle in its traveling after the weighted integration, Weight_S is the shortest distance that a driver needs to maintain from a preceding vehicle after the weighted integration, Weight_T is the expected amount of time for the vehicle to pass the dense region, α is a weight of the information from the drone, 1−α is a weight of the information from the downstream vehicle.

Compared with the prior art, the present disclosure has the following the beneficial effects:

1) The present disclosure mainly includes inducing a vehicle that is already in a dense region by transmitting real-time traffic guidance information to a vehicle-mounted terminal, so that complex traffic condition information in the dense region is converted into traffic guidance information that the driver can perceive directly, and based on the directly perceived data the driver can drive away from the dense region more safely and smoothly.

2) By using a drone to acquire traffic condition information, instead of the commonly-used ground-level sensor coil and roadside camera, the present disclosure provides a higher deployment flexibility. In addition, the present disclosure adopts a method that weights the information from the drone and information from a downstream vehicle, which makes the calculation result more accurate, hence a higher accuracy. Finally, the present disclosure transmits the traffic guidance information to the vehicle-mounted terminal instead of a roadside variable message board, which converts the induction process from passive to active, more human-perceivable.

3) By displaying a recommended vehicle speed for an upstream vehicle, the present disclosure can effectively reduce the driver's frequent “start-stop” maneuver, so that the vehicle can pass the dense region slowly and smoothly, thereby alleviating the road congestion problem, and reducing exhaust emissions and saving energy. In addition, by displaying an expected time to pass the vehicle-dense region, the present disclosure can effectively reduce the driver's inner nervousness and anxiety, thereby reducing the likelihood of the driver making a mistake and effectively reducing the occurrence of traffic accidents. Finally, the present disclosure can self-adapt according to different road surface status so that the shortest distance displayed reflects the current situation; when the driver obtains the information on the shortest distance to maintain, the driver has a better control over the vehicle. Less experienced drivers can adjust accordingly to avoid traffic accidents caused by short distances, even if they are driving in a region with imperfect road surface status.

### BRIEF DESCRIPTION OF THE DRAWINGS

FIG. 1 is a flow chart of a method for guiding traffic flow in vehicle-dense regions based on a three-dimensional traffic system according to the present disclosure.

### DETAILED DESCRIPTION OF PARTICULAR EMBODIMENTS

The embodiments of the present disclosure will be described in detail below with reference to the accompanying drawings. The embodiments are for illustrative purposes only and shall not be construed as limiting the scope of the present invention.

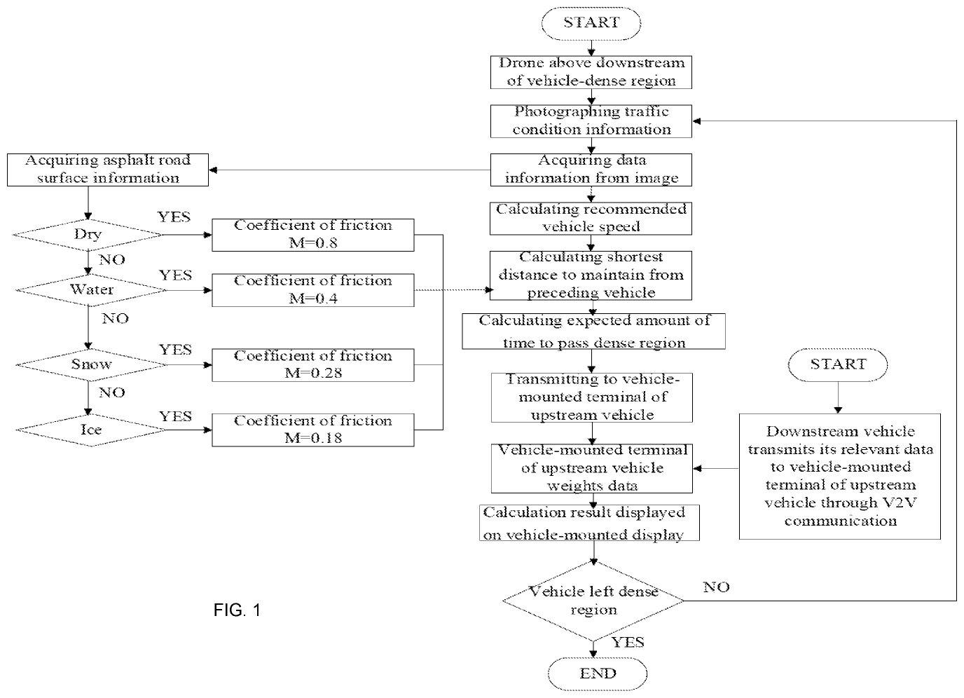

FIG. 1 is a flow chart of a method for guiding traffic flow in vehicle-dense regions based on a three-dimensional traffic system according to the present disclosure. It can be seen from FIG. 1 that the method for guiding traffic flow in vehicle-dense regions according to the present disclosure is realized based on the drone technology, which can provide good traffic guidance for a three-dimensional traffic system. The method specifically includes the following steps.

Step S1: remotely controlling a drone to fly above the downstream of a vehicle-dense region, and adjusting the flight status of the drone and the angle of a camera on the drone so that the camera faces stably and directly towards the ground. In this case, the number of vehicles in the region is m, vehicle identifier is Nᵥ, where Nᵥ=1, 2, . . . , m; the number of drones positioned above the downstream of the region is n, drone identifier is Nₐ, where Nₐ=1, 2, . . . , n.

Step S2: aerially photographing traffic condition information of the vehicle-dense region through drone aerial photography technology, and acquiring by the drone image data information from a captured traffic condition information image, where the image data information includes road surface status information of the vehicle-dense region, the height of the drone from the ground of the vehicle-dense region, and the distance between the drone and a vehicle at different times.

In practice, because three-dimensional traffic is mostly arranged in cites, the collecting road surface status information in the present disclosure is mainly directed to asphalt road surface in cities; however, it is noted that the method for guiding traffic flow of the present disclosure can bring good results with non-asphalt road surface. The road surface status information according to the present disclosure may include: whether the road surface is dry, whether the road surface has accumulated water, whether the road surface has snow accumulation and whether the road surface has ice.

Preferably, according to an embodiment the acquiring image data information from a captured image by the drone includes performing data analysis on the image and calculating traffic guidance information according to the analyzed data. The traffic guidance information includes a recommended vehicle speed in the traveling of the vehicle, a shortest distance that the driver needs to maintain from a preceding vehicle, and an expected amount of time for the vehicle to pass the dense region.

Step S3: determining by the drone traffic guidance information for a vehicle upstream to the vehicle-dense region according to the image data information acquired in step S2, where the traffic guidance information includes a recommended vehicle speed in the traveling of the vehicle, a shortest distance that the driver needs to maintain from a preceding vehicle, and an expected amount of time for the vehicle to pass the dense region.

In practice, the traffic guidance information for an upstream vehicle can be determined in various manners, e.g., by doing a statistical analysis on traveling information of vehicles in the vehicle-dense region as in the prior art to determine the traffic guidance information of the vehicle-dense region, or by calculation as described in the present disclosure.

In order to transmit a more accurate traffic guidance information to a vehicle upstream to the vehicle-dense region, the present disclosure provides a calculation method as follows:

First, the drone acquires the following data from the captured image:

A. at time t₁, the distance l₁ between a drone Nₐ and a vehicle Nᵥ;

B. at time t₂, the distance l₂ between the drone Nₐ and the vehicle Nᵥ;

C. the height h of the drone Nₐ from the ground;

D. asphalt road surface status information.

Next, a recommended speed for an upstream vehicle Weight_V̅₁ is calculated. The calculation of the recommended speed for an upstream vehicle Weight_V̅₁ includes:

A. calculating an angle θ₁ between a line that connects the drone Nₐ and the vehicle Nᵥ and the ground at the time t₁ according to a calculation formula:

$${θ}_{1} = {sin}^{- 1} \frac{h}{{l}_{1}} \text{;} \qquad ( 8 )$$

B. calculating an angle θ₂ between a line that connects the drone Nₐ and the vehicle Nᵥ and the ground at the time t₂ according to a calculation formula:

$${θ}_{2} = {sin}^{- 1} \frac{h}{{l}_{2}} \text{;} \qquad ( 9 )$$

C. calculating a distance X that the vehicle Nᵥ travels from the time t₁ to the time t₂:

X=x₁+x₂ (10),

where x₁ and x₂ are calculated according to calculation formulas:

x₁=l₁ cos θ₁ (11)

x₂=l₂ cos θ₁ (12);

By combination equations (8)-(12), equation (13) can be obtained:

$$X = {l}_{1} cos {sin}^{- 1} \frac{h}{{l}_{1}} + {l}_{2} cos {sin}^{- 1} \frac{h}{{l}_{2}} . \qquad ( 13 )$$

Observing m₁ vehicles and calculating an average interval speed:

$${\overline{V}}_{1} = \frac{1}{\frac{1}{{m}_{1}} {\sum }_{i = 1}^{{m}_{1}} \frac{T}{X}} \text{;} \qquad ( 14 )$$

By substituting equation (13) into equation (14), equation (15) can be obtained:

$${\overline{V}}_{1} = \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} . \qquad ( 15 )$$

V̅₁ is the average interval speed calculated by the drone Nₐ. Then, calculation results from n drones are weighted. Because the n drones may have different camera accuracies and different hovering stabilities, it is assumed that the respective weights of the Nₐ=1, 2, . . . , n drones are xᵢ=x₁, x₂, . . . , xₙ. Upon weighting, an average traveling speed of the downstream vehicles, i.e., the recommended speed for an upstream vehicle is calculated according to a calculation formula:

$$Weight\_ {\overline{V}}_{1} = \frac{{\sum }_{i = 1}^{n} \frac{1}{\frac{1}{{m}_{1}} {\sum }_{i = 1}^{{m}_{1}} \frac{{t}_{2} - {t}_{1}}{\begin{matrix}{l}_{1} cos {sin}^{- 1} \frac{h}{{l}_{1}} + \\ {l}_{2} cos {sin}^{- 1} \frac{h}{{l}_{2}}\end{matrix}}} \cdot {x}_{i}}{{\sum }_{i = 1}^{n} {x}_{i}} \qquad ( 1 )$$

D. calculating a shortest distance that the driver needs to maintain from a preceding vehicle (i.e., braking distance) according to a calculation formula:

$${S}_{1} = \frac{Weight\_ {\overline{V}}_{1}^{2}}{2 g μ} . \qquad ( 16 )$$

In equation (16), μ is a coefficient of friction between the vehicle tire and the road surface (preferably asphalt). The asphalt road surface status information can be acquired from analyzing the image captured by the drone. When the asphalt road surface is dry, μ=0.8; when the asphalt road surface has accumulated water, μ=0.4; when the asphalt road surface has snow accumulation, μ=0.28; when the asphalt road surface has ice, μ=0.18, g=9.8 m/s². By substituting equation (1) into equation (16), the shortest distance S₁ that the driver needs to maintain from a preceding vehicle can be obtained according to a calculation formula:

$${S}_{1} = \frac{\frac{{\sum }_{i = 1}^{n} \frac{1}{\frac{1}{{m}_{1}} {\sum }_{i = 1}^{{m}_{1}} \frac{{t}_{2} - {t}_{1}}{\begin{matrix}{l}_{1} cos {sin}^{- 1} \frac{h}{{l}_{1}} + \\ {l}_{2} cos {sin}^{- 1} \frac{h}{{l}_{2}}\end{matrix}}} \cdot {x}_{i}^{2}}{{\sum }_{i = 1}^{n} {x}_{i}}}{2 g μ} . \qquad ( 2 )$$

calculating an expected amount of time T₁ for an upstream vehicle to pass the dense region in its traveling according to a calculation formula:

$${T}_{1} = \frac{L}{\frac{{\sum }_{i = 1}^{n} \frac{1}{\frac{1}{{m}_{1}} {\sum }_{i = 1}^{{m}_{1}} \frac{{t}_{2} - {t}_{1}}{\begin{matrix}{l}_{1} cos {sin}^{- 1} \frac{h}{{l}_{1}} + \\ {l}_{2} cos {sin}^{- 1} \frac{h}{{l}_{2}}\end{matrix}}} \cdot {x}_{i}}{{\sum }_{i = 1}^{n} {x}_{i}}} . \qquad ( 3 )$$

Step S4: transmitting the calculated traffic guidance information to a vehicle-mounted terminal on a vehicle upstream to the dense region.

Specifically, step S4 may include: transmitting by the drone the traffic guidance information determined in step S3 to a vehicle-mounted terminal of an upstream vehicle, and transmitting by a vehicle downstream to the vehicle-dense region its traffic guidance information to the vehicle-mounted terminal of the upstream vehicle through V2V communication technology.

In the above technical solution, the traffic guidance information of the downstream vehicle itself in step S4 may also be obtained from calculation. Specifically, given a real-time downstream vehicle speed V₂, m₂ vehicles have an average speed V̅₂ from the time t₁ to the time t₂ that can be calculated according to a calculation formula:

$${\overline{V}}_{2} = \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \text{;} \qquad ( 4 )$$

In the traveling of the downstream vehicles m₂, a shortest distance S₂ that the driver needs to maintain from a preceding vehicle is calculated according to a calculation formula:

$${S}_{2} = \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \text{;} \qquad ( 5 )$$

In the traveling of the downstream vehicles m₂, an expected amount of time T₂ for the vehicle to pass the dense region is calculated according to a calculation formula:

$${T}_{2} = \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}} . \qquad ( 6 )$$

S5: weighting by the vehicle-mounted terminal of the upstream vehicle the traffic guidance information from the drone (step S4) and the traffic guidance information from the downstream vehicle, and transmitting a traffic guidance information result from the weighting to a vehicle display.

In this case, the vehicle-mounted terminal on the upstream vehicle receives two sets of information, one being the traffic guidance information from the drone, the other being the traffic guidance information transmitted from the downstream vehicle through V2V communication technology. The two sets of information are weighted, assuming that the weight of the information from the drone is α, and the weight of the information from the downstream vehicle is 1−α. The weights here depend on the level of accuracy of the information; and factors that may affect the level of accuracy include: error in drone photographing, systematic error in data acquisition by the drone and the vehicle, anti-jamming capability of the communication technology used, etc.

The traffic guidance information from step S5 is obtained based on the traffic guidance information calculated in steps S3 and S4, and calculated through weighting. The traffic guidance information from step S5 is calculated according to a calculation formula:

$$\{ \begin{matrix}Weight\_V = α \cdot \frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}} + ( 1 - α ) \cdot \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \\ Weight\_S = α \cdot \frac{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{2}} + {l}_{2} cos {sin}^{- 1} \frac{h}{{t}_{2}}}} \cdot {x}_{i}^{2}}{{\sum }_{i = 1}^{n} {x}_{i}}}{2 g μ} + ( 1 - α ) \cdot \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \\ Weight\_T = α \cdot \frac{L}{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}}} + ( 1 - α ) \cdot \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}}\end{matrix} \text{;} \qquad ( 7 )$$

S6: maintaining by a driver of the upstream vehicle a safe distance from a preceding vehicle according to information displayed on its vehicle display, and driving smoothly according to the recommended vehicle speed until the vehicle leaves the vehicle-dense region.

In practice, V2V communication may be realized by a known technology. In addition, for a better understanding of the technical solutions of the present disclosure, the symbols used in the present disclosure have the meanings below.

L is the length of the vehicle-dense region, m is the number of vehicles in the vehicle-dense region, vehicle identifier is Nᵥ, where Nᵥ=1, 2, . . . , m, n is the number of drones in the vehicle-dense region, drone identifier is Nₐ, where Nₐ=1, 2, . . . , n.

xᵢ is the distance that a vehicle travels at different time, i is a natural number, x₁ is the distance that a vehicle travels at time t₁, x₂ is the distance that a vehicle travels at time t₂, t₁ and t₂ are different times that a drone aerially photographs, h is the height of the drone from the ground, l₁ is the distance between a drone Nₐ and a vehicle Nᵥ at time t₁, l₂ is the distance between a drone Nₐ and a vehicle Nᵥ at time t₂.

g is the gravitational acceleration, μ is a coefficient of friction between a vehicle tire and a road surface. Specifically, when an asphalt road surface is dry, the coefficient of friction between a vehicle tire and a road surface μ=0.8; when an asphalt road surface has accumulated water, the coefficient of friction between a vehicle tire and a road surface μ=0.4; when an asphalt road surface has snow accumulation, the coefficient of friction between a vehicle tire and a road surface μ=0.28; when an asphalt road surface has ice, the coefficient of friction between a vehicle tire and a road surface μ=0.18.

Weight_V is the recommended speed for a vehicle in its traveling after the weighted integration, Weight_S is the shortest distance that a driver needs to maintain from a preceding vehicle after the weighted integration, Weight_T is the expected amount of time for the vehicle to pass the dense region, α is the weight of the information from the drone, 1−α is the weight of the information from the downstream vehicle.

In practice, as shown in FIG. 1, for a clearer understanding of the complete technical solutions of the present disclosure, by way of example, a preferred method for guiding traffic flow according to the present disclosure is described below where the road surface is asphalt.

K1) remotely controlling a drone to fly above the downstream of a vehicle-dense region;

K2) photographing by cameras on the drone traffic condition information of the vehicle-dense region;

K3) acquiring by the drone required data information from the captured images;

Specifically, the data information in step K3 includes traffic flow data information and asphalt road surface status information. The traffic flow data information can be obtained according to the method described previously in step S3; the asphalt road surface status information can be obtained according to the following steps:

K3.1) determining whether the asphalt road surface is dry, and if so, determining the coefficient of friction between the vehicle tire and the road surface μ=0.8 in the calculation of the traffic guidance information; if not, proceeding to the next step;

K3.2) determining whether the asphalt road surface has accumulated water, and if so, determining the coefficient of friction between the vehicle tire and the road surface μ=0.4 in the calculation of the traffic guidance information; if not, proceeding to the next step;

K3.3) determining whether the asphalt road surface has snow accumulation, and if so, determining the coefficient of friction between the vehicle tire and the road surface μ=0.28 in the calculation of the traffic guidance information; if not, proceeding to the next step;

K3.4) determining whether when the asphalt road surface has ice, and if so, determining the coefficient of friction between the vehicle tire and the road surface μ=0.18 in the calculation of the traffic guidance information; if not, proceeding to the next step;

K4) calculating a recommended vehicle speed in the traveling of the vehicle according to the traffic guidance information determined in step K3. For specific calculation method, please refer to the description in step S3 above.

K5) calculating a shortest distance that the driver needs to maintain from a preceding vehicle (i.e., braking distance) according to the traffic guidance information and the asphalt road surface status information determined in step K3;

K6) calculating an expected amount of time for an upstream vehicle to pass the dense region according to the recommended vehicle speed in the traveling of the vehicle determined in step K4;

K7) transmitting the traffic guidance information calculated in steps K4 to K6 to a vehicle-mounted terminal of an upstream vehicle; and at the same time, transmitting by a vehicle downstream its relevant data to the vehicle-mounted terminal on the upstream vehicle through V2V communication technology;

K8) weighting by the vehicle-mounted terminal of the upstream vehicle the data from the drone and from the downstream vehicle, and transmitting a calculation result to a vehicle display. For specific calculation method, please refer to the description in step S5 above. At this time, the vehicle display of the upstream vehicle displays traffic guidance information suggested for the user passing the vehicle-dense region.

K9) driving by the driver according to the traffic guidance information displayed on the vehicle display until the vehicle leaves the vehicle-dense region. That is, when the vehicle has not left the dense route, the vehicle display of the upstream vehicle continues displaying traffic guidance information of the vehicle-dense region; when the vehicle has left the dense rout, the method for guiding traffic flow according to the present disclosure ends.

The present disclosure can convert complex traffic condition information in the dense region into traffic guidance information that the driver can perceive directly, and effectively reduce the driver's frequent “start-stop” maneuver, so that the vehicle can pass the dense region slowly and smoothly, thereby alleviating city road congestion problems, reducing the occurrence of traffic accidents, and reducing exhaust emissions and saving energy.

Those that are not described here belong to the prior art.

1-5. (canceled)

6. A method for guiding traffic flow in vehicle-dense regions based on a three-dimensional traffic system, said method comprising the steps of:
(a) remotely controlling a drone to fly above the downstream of a vehicle-dense region, and adjusting a flight status of the drone and an angle of a camera on the drone so that the camera faces stably and directly towards the ground;
(b) aerially photographing traffic condition information of the vehicle-dense region through drone aerial photography technology, and acquiring by the drone image data information from a captured traffic condition information image, where the image data information comprises road surface status information of the vehicle-dense region, the height of the drone from the ground of the vehicle-dense region, and the distance between the drone and a vehicle at different times;
(c) determining, by the drone, traffic guidance information for a vehicle upstream to the vehicle-dense region according to the image data information acquired in step (b), where the traffic guidance information comprises a recommended vehicle speed in the traveling of the vehicle, a shortest distance that the driver needs to maintain from a preceding vehicle, and an expected amount of time for the vehicle to pass the dense region;
(d) transmitting, by the drone, the traffic guidance information determined in step (c) to a vehicle-mounted terminal of an upstream vehicle; and transmitting, by a vehicle downstream to the vehicle-dense region, its traffic guidance information to the vehicle-mounted terminal of the upstream vehicle through V2V communication technology;
(e) weighting, by the vehicle-mounted terminal of the upstream vehicle, the traffic guidance information from the drone and the traffic guidance information from the downstream vehicle, and transmitting a traffic guidance information result from the weighting to a vehicle display; and
(f) maintaining, by a driver of the upstream vehicle, a safe distance from a preceding vehicle according to information displayed on its vehicle display, and driving smoothly according to the recommended vehicle speed until the vehicle leaves the vehicle-dense region.

7. The method for guiding traffic flow in vehicle-dense regions based on a three-dimensional traffic system according to claim 6, wherein the traffic guidance information in step (c) is determined by calculation; the recommended speed Weight_V̅₁ for an upstream vehicle in the traveling of the vehicle is calculated according to a calculation formula:
$$Weight\_ {\overline{V}}_{1} = \frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}} \text{;} \qquad ( 1 )$$
the shortest distance S₁ that the driver needs to maintain from a preceding vehicle in the traveling of the upstream vehicle is calculated according to a calculation formula:
$$( 2 )$$
$${S}_{1} = \frac{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}^{2}}{{\sum }_{i = 1}^{n} {x}_{i}}}{2 g μ} \text{;}$$
the expected amount of time T1 for the upstream vehicle to pass the dense region in its traveling is calculated according to a calculation formula:
$$( 3 )$$
$${T}_{1} = \frac{L}{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}}} ,$$
wherein
L is the remaining length of the vehicle-dense region;
m1 is the number of vehicles in the vehicle-dense region that are observed by the drone, vehicle identifier is Nᵥ, where Nᵥ=1, 2, . . . , m;
n is the number of drones in the vehicle-dense region, drone identifier is Nₐ, where Nₐ=1, 2, . . . , n:
xᵢ is a weight assigned to the Nₐ=1, 2, . . . , n drones, i is a natural number;
t₁ and t₂ are different times that the drone aerially photographs;
h is the height of the drone from the ground;
l₁ is the distance between a drone Nₐ and a vehicle Nᵥ at time t₁;
l₂ is the distance between a drone Nₐ and a vehicle Nᵥ at time t₂;
g is the gravitational acceleration; and
μ is a coefficient of friction between a vehicle tire and a road surface.

8. The method for guiding traffic flow in vehicle-dense regions based on a three-dimensional traffic system according to claim 7, wherein when an asphalt road surface is dry, the coefficient of friction between a vehicle tire and a road surface μ=0.8; when an asphalt road surface has accumulated water, the coefficient of friction between a vehicle tire and a road surface μ=0.4; when an asphalt road surface has snow accumulation, the coefficient of friction between a vehicle tire and a road surface μ=0.28; when an asphalt road surface has ice, the coefficient of friction between a vehicle tire and a road surface μ=0.18.

9. The method for guiding traffic flow in vehicle-dense regions based on a three-dimensional traffic system according to claim 7, wherein the traffic guidance information of the downstream vehicle itself in step (d) is obtained by calculation; given a real-time downstream vehicle speed V₂, m₂ vehicles have an average speed V̅₂ from the time t₁ to the time t₂ that can be calculated according to a calculation formula:
$${\overline{V}}_{2} = \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \text{;} \qquad ( 4 )$$
in the traveling of the downstream vehicle, a shortest distance S₂ that the driver needs to maintain from a preceding vehicle is calculated according to a calculation formula:
$${S}_{2} = \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \text{;} \qquad ( 5 )$$
in the traveling of the downstream vehicles, an expected amount of time T₂ for the vehicle to pass the dense region is calculated according to a calculation formula:
$${T}_{2} = \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}} , \qquad ( 6 )$$
wherein m₂ is the number of vehicles that are in the range of V2V communication of the vehicle upstream to the vehicle-dense region.

10. The method for guiding traffic flow in vehicle-dense regions based on a three-dimensional traffic system according to claim 8, wherein the traffic guidance information of the downstream vehicle itself in step (d) is obtained by calculation; given a real-time downstream vehicle speed V₂, m₂ vehicles have an average speed V̅₂ from the time t₁ to the time t₂ that can be calculated according to a calculation formula:
$${\overline{V}}_{2} = \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \text{;} \qquad ( 4 )$$
in the traveling of the downstream vehicle, a shortest distance S₂ that the driver needs to maintain from a preceding vehicle is calculated according to a calculation formula:
$${S}_{2} = \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \text{;} \qquad ( 5 )$$
in the traveling of the downstream vehicles, an expected amount of time T₂ for the vehicle to pass the dense region is calculated according to a calculation formula:
$${T}_{2} = \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}} , \qquad ( 6 )$$
wherein m₂ is the number of vehicles that are in the range of V2V communication of the vehicle upstream to the vehicle-dense region.

11. The method for guiding traffic flow in vehicle-dense regions based on a three-dimensional traffic system according to claim 9, wherein the traffic guidance information from step (e) is obtained based on the traffic guidance information calculated in steps (c) and (d), and calculated through weighting; the traffic guidance information from step (e) is calculated according to a calculation formula:
$$\{ \begin{matrix}Weight\_V = α \cdot \frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}} + ( 1 - α ) \cdot \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \\ Weight\_S = α \cdot \frac{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{2}} + {l}_{2} cos {sin}^{- 1} \frac{h}{{t}_{2}}}} \cdot {x}_{i}^{2}}{{\sum }_{i = 1}^{n} {x}_{i}}}{2 g μ} + ( 1 - α ) \cdot \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \\ Weight\_T = α \cdot \frac{L}{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}}} + ( 1 - α ) \cdot \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}}\end{matrix} , \qquad ( 7 )$$
wherein,
Weight_V is the recommended speed for a vehicle in its traveling after the weighted integration;
Weight_S is the shortest distance that a driver needs to maintain from a preceding vehicle after the weighted integration;
Weight_T is the expected amount of time for the vehicle to pass the dense region;
α is a weight of the information from the drone; and
1−α is a weight of the information from the downstream vehicle.

12. The method for guiding traffic flow in vehicle-dense regions based on a three-dimensional traffic system according to claim 10, wherein the traffic guidance information from step (e) is obtained based on the traffic guidance information calculated in steps (c) and (d), and calculated through weighting; the traffic guidance information from step (e) is calculated according to a calculation formula:
$$\{ \begin{matrix}Weight\_V = α \cdot \frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}} + ( 1 - α ) \cdot \frac{1}{{m}_{2}} {\sum }_{i = 1}^{{m}_{2}} \frac{{\int }_{{t}_{1}}^{{t}_{2}} {V}_{2}}{{t}_{2} - {t}_{1}} \\ Weight\_S = α \cdot \frac{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{2}} + {l}_{2} cos {sin}^{- 1} \frac{h}{{t}_{2}}}} \cdot {x}_{i}^{2}}{{\sum }_{i = 1}^{n} {x}_{i}}}{2 g μ} + ( 1 - α ) \cdot \frac{\frac{1}{{m}_{2}} {\sum }_{i = 1}^{{m}_{2}} \frac{{\int }_{{t}_{1}}^{{t}_{2}} {V}_{2}^{2}}{{t}_{2} - {t}_{1}}}{2 g μ} \\ Weight\_T = α \cdot \frac{L}{\frac{{\sum }_{i = 1}^{n} \frac{1}{\frac{1}{{m}_{1}} {\sum }_{i = 1}^{{m}_{1}} \frac{{t}_{2} - {t}_{1}}{{l}_{1} cos {sin}^{- 1} \frac{h}{{l}_{1}} + {l}_{2} cos {sin}^{- 1} \frac{h}{{l}_{2}}}} \cdot {x}_{i}}{{\sum }_{i = 1}^{n} {x}_{i}}} + ( 1 - α ) \cdot \frac{L}{\frac{1}{{m}_{2}} {\sum }_{i = 1}^{{m}_{2}} \frac{{\int }_{{t}_{1}}^{{t}_{2}} {V}_{2}}{{t}_{2} - {t}_{1}}}\end{matrix} , \qquad ( 7 )$$
wherein
Weight_V is the recommended speed for a vehicle in its traveling after the weighted integration;
Weight_S is the shortest distance that a driver needs to maintain from a preceding vehicle after the weighted integration;
Weight_T is the expected amount of time for the vehicle to pass the dense region;
α is a weight of the information from the drone; and
1−α is a weight of the information from the downstream vehicle.
